(19) United States
(12) Patent Application Publication
(10) Pub. No.: US 2010/0285319 A1
(43) Pub. Date: Nov. 11, 2010

(54) METHOD FOR FABRICATION OF TRANSPARENT GAS BARRIER FILM USING PLASMA SURFACE TREATMENT AND TRANSPARENT GAS BARRIER FILM FABRICATED THEREBY

(76) Inventors: Soonjong Kwak, Seoul (KR); Jae Ho Jun, Seoul (KR)

Correspondence Address: JONES DAY, 222 EAST 41ST ST, NEW YORK, NY, 10017, US

(21) Appl. No.: 12/811,762

(22) PCT Filed: Jan. 7, 2009
(86) PCT No.: PCT/KR09/00062

§ 371 Date: Jul. 6, 2010

(30) Foreign Application Priority Data
Jan. 7, 2008 (KR) 10-2008-0001674
Dec. 30, 2008 (KR) 10-2008-0136382

(51) Int. Cl. B32B 27/00; H05H 1/00; B05D 3/06

(52) U.S. Cl. 428/411.1; 427/536

(57) ABSTRACT

The present invention relates to a method of fabricating a transparent gas barrier film by using plasma surface treatment and a transparent gas barrier film fabricated according to such method which has an organic/inorganic gradient interface structure at the interface between an organic/inorganic hybrid layer and an inorganic layer. Since the method of the present invention is capable of fabricating a gas barrier film by plasma surface treatment instead of deposition under high vacuum, it can mass-produce a transparent gas barrier film with excellent gas barrier properties in an economical and simple manner. Further, since the transparent gas barrier film fabricated according to the method of the present invention shows excellent gas barrier properties and is free of crack formation and layer-peeling phenomenon, it can be effectively used in the manufacture of a variety of display panels.

### TECHNICAL FIELD

The present invention relates to a method of fabricating a transparent gas barrier film by using plasma surface treatment and such fabricated transparent gas barrier film which shows excellent gas barrier properties and is free of crack formation and layer-peeling phenomenon.

### BACKGROUND ART

As information communication technologies are being developed, the demand for display panels used in various electronic devices including TV, cellular phones, notebook computers, PDA, LCD monitors, automobile navigators, portable game devices and the like, is on the rise. In particular, a major increase in the usage of large-size LCD TVs and portable electronic devices has led to more customers with a preference for slim and lightweight products and an effort to reduce the weight and thickness of the display panel.

The conventional display panels are made of glass and have the advantage of being transparent and solid, but are problematic in that they are fragile, lack flexibility, and have a high weight per unit volume. Thus, it has been very difficult to manufacture a slim and lightweight display panel with high flexibility and shock-resistance. As an alternative that overcomes the above-mentioned deficiencies of the conventional glass substrate, transparent plastic substrates have been proposed.

Since plastic substrates are thinner, lighter, and more flexible than the glass substrate, they can be produced by using a roll-to-roll process and fabricated into a flexible display. However, their thermal resistance, chemical resistance, and dimensional stability are lower than those of the glass substrate, and in particular, the plastic substrates have a relatively higher thermal expansion coefficient and gas permeability compared to glass. In particular, when the plastic substrate is used for LCDs or organic ELs, the high gas permeability of the plastic substrate causes oxygen or water vapor to penetrate, leading to fundamental problems in function such as loss of LCD or organic EL function or separation of metal electrode. Since such problems relating to the gas permeability of the plastic substrate are difficult to overcome by improving the performance of the plastic substrate itself, methods of coating the surface of the plastic substrate with a thin film capable of preventing the penetration of gas, such as oxygen and water vapor, have been used.

Any material, organic or inorganic, may be used as the gas barrier film, so long as it exhibits high light transmittance, good surface hardness and high thermal resistance as well as excellent gas barrier properties. In general, suitable materials for gas barrier film include transparent inorganic materials such as silicon oxides (SiOₓ), aluminum oxides (AlₓO_{y}), tantalum oxides (TaₓO_{y}), titanium oxides (TiOₓ) and the like. Such gas barrier film can be coated on the surface of the plastic substrate by a vacuum deposition method, such as plasma-enhanced chemical vapor deposition (PECVD), sputtering and the like, or a sol-gel method.

Such gas barrier films include various forms, such as films composed of a single inorganic layer; a bilayer having an organic layer and an inorganic layer; a triple-layer having an organic layer/inorganic layer/organic layer structure or an inorganic layer/organic layer/inorganic layer structure; and a repetitive layer structure, but generally include at least one inorganic layer. Here, the organic layer functions not so much as a gas barrier but more as a layer that prevents any defects occurring in the inorganic layer from spreading to the next inorganic layer.

However, in cases of directly coating an inorganic layer on the surface of a plastic substrate, there are problems with respect to formation of cracks or layer-peeling at the interface of the two layers due to the difference in physical properties of each layer and the clear interface between the layers. For instance, Japanese Patent No. 1994-0031850 and 2005-0119148 disclose methods of coating an inorganic layer on the surface of a plastic substrate directly by sputtering, where, when external heat or repetitive force is applied or the plastic substrate is bent, the interface between the inorganic layer and the plastic substrate is exposed to stress, leading to the formation of cracks and layer-peeling, due to the significantly different physical properties (e.g., elastic modulus, thermal expansion coefficient, band radius etc) between the inorganic layer and the plastic substrate. In order to prevent these problems, Japanese Patent No. 2003-0260749 discloses a method of reducing the drastic change in physical properties at the interface by introducing an organic/inorganic hybrid layer between the plastic substrate and the inorganic layer. However, despite the introduction of an intermediate layer such as an organic/inorganic hybrid layer, the physical property of each layer is still different and the interface between the intermediate layer and the inorganic layer exists. Therefore, there is still a possibility that the above method could lead to the formation of cracks and layer-peeling at the interface. Further, Japanese Patent No. 2004-0082598 discloses a method of using a multi-layer gas barrier film which is composed of an organic layer and an inorganic layer for improving gas barrier properties, but is still problematic because of the increased possibilities of forming cracks and layer-peeling at each of the interface between the many layers having different physical properties. Furthermore, since the fabrication of conventional gas barrier films by a deposition process under high vacuum requires expensive vacuum deposition apparatus and takes a long time to reach the desired high vacuum, it has the problem of being economically unfavorable.

The inventors of the present invention have therefore endeavored to overcome the problems of the conventional gas barrier films and fabrication method thereof and developed a method of fabricating a gas barrier film by forming an inorganic layer by surface plasma treatment of an organic/inorganic hybrid layer instead of high vacuum deposition. It has been found that the method of the present invention can fabricate a gas barrier film having an organic/inorganic gradient interface structure showing a gradual change in constitution from inorganic materials to organic/inorganic materials, which exhibits excellent gas barrier properties and is free of crack formation and layer-peeling phenomenon.

### DISCLOSURE

### Technical Problem

The present invention is directed to overcoming the above deficiencies in the art. One of the objectives of the present invention is to provide a transparent gas barrier film which shows excellent gas barrier properties and is free of crack formation and layer-peeling phenomenon, as well as a simple and economic method of fabricating the same that does not use high vacuum deposition.

### Technical Solution

One aspect of the present invention relates to a method of fabricating a transparent gas barrier film which comprises the step of forming an inorganic layer by treating the surface of an organic/inorganic hybrid layer with plasma of reactive gas.

Another aspect of the present invention relates to a transparent gas barrier film fabricated by the above method, which includes an organic/inorganic hybrid layer and an inorganic layer as a gas barrier layer, where the interface between the organic/inorganic hybrid layer and the inorganic layer has an organic/inorganic gradient interface structure showing a gradual change in constitution from inorganic materials to organic/inorganic materials.

### INDUSTRIAL APPLICABILITY

Since the method of the present invention is capable of fabricating a gas barrier film by plasma surface treatment instead of deposition under high vacuum, it can mass-produce transparent gas barrier films having excellent gas barrier properties in an economical and simple manner. The transparent gas barrier film fabricated according to the method of the present invention has advantages in that there is no crack formation or layer-peeling phenomenon at the interface between the organic/inorganic hybrid layer and the inorganic layer due to the presence of an organic/inorganic gradient interface structure. Further, it exhibits high light transmittance, good surface hardness and high thermal resistance as well as excellent gas barrier properties. Therefore, the transparent gas barrier film of the present invention can be effectively used in the manufacture of a variety of display panels.

### DESCRIPTION OF DRAWINGS

The embodiments of the present invention will be described in detail with reference to the following drawings.

FIG. 1 shows a scanning electron microscope (SEM) photograph of an inorganic layer and an organic/inorganic hybrid layer having an organic/inorganic gradient interface structure at a cross section of a transparent gas barrier film fabricated according to the present invention.

FIG. 2 is a schematic diagram illustrating the cross section of a transparent gas barrier film fabricated according to one embodiment of the present invention. 1: transparent plastic film; 2: organic/inorganic hybrid layer; 3: inorganic layer having an organic/inorganic gradient interface structure.

FIG. 3 is a schematic diagram illustrating the cross section of a transparent gas barrier film fabricated according to another embodiment of the present invention. 1: transparent plastic film; 2: organic/inorganic hybrid layer; 3: inorganic layer having an organic/inorganic gradient interface structure.

FIG. 4 is a schematic diagram illustrating the cross section of a transparent gas barrier film fabricated according to another embodiment of the present invention. 1: transparent plastic film; 2: organic/inorganic hybrid layer; 3: inorganic layer having an organic/inorganic gradient interface structure.

FIG. 5 is a schematic diagram illustrating the cross section of a transparent gas barrier film fabricated according to another embodiment of the present invention. 1: transparent plastic film; 2: organic/inorganic hybrid layer; 3: inorganic layer having an organic/inorganic gradient interface structure.

FIG. 6 is a schematic diagram illustrating the cross section of a transparent gas barrier film fabricated according to another embodiment of the present invention. 1: transparent plastic film; 2: organic/inorganic hybrid layer; 3: inorganic layer having an organic/inorganic gradient interface structure.

### BEST MODE FOR CARRYING OUT THE INVENTION

The present invention provides a transparent gas barrier film with excellent gas barrier properties which comprises a transparent plastic substrate, an organic/inorganic hybrid layer and an inorganic layer, where the interface between the organic/inorganic hybrid layer and the inorganic layer has an organic/inorganic gradient interface structure showing a gradual change in composition from inorganic materials to organic/inorganic materials.

The transparent gas barrier film according to the present invention can be fabricated by a method comprising the following steps:

a) coating an organic/inorganic hybrid solution on the surface of a transparent plastic film to form an organic/inorganic hybrid layer; and

b) treating the surface of the organic/inorganic hybrid layer formed on the transparent plastic film with plasma of reactive gas to form an inorganic layer having an organic/inorganic gradient interface structure.

The transparent gas barrier film according to the present invention includes an inorganic layer and an organic/inorganic hybrid layer as a gas barrier layer, which is characterized in that the interface between them has an organic/inorganic gradient interface structure showing a gradual change in composition from inorganic materials to organic/inorganic materials. Such characteristics are achieved not by depositing an inorganic layer onto an organic/inorganic hybrid layer coated on a transparent plastic film under high vacuum, but by removing hydrocarbons from the surface of an organic/inorganic hybrid layer through plasma surface treatment and, thereby, converting a portion of the organic/inorganic hybrid layer into an inorganic layer.

The term “organic/inorganic gradient interface structure” as used herein refers to a structure in which there is no drastic change in chemical composition at the interface between the inorganic layer and the organic/inorganic hybrid layer and there is a gradual change in composition from inorganic materials to organic/inorganic materials, moving from the inorganic layer to the organic/inorganic hybrid layer. Since the transparent gas barrier film having an organic/inorganic gradient interface structure according to the present invention does not have a clear boundary between the inorganic layer and the organic/inorganic hybrid layer, there is no crack formation or layer-peeling phenomenon at the interface.

Hereinafter, the method of fabricating the transparent gas barrier film according to the present invention will be described in more detail.

Any type of polymer may be used as a transparent plastic film in step a) so long as it is a thermoplastic polymer or a thermosetting polymer capable of forming a film with excellent optical properties. Suitable thermoplastic polymers for the present invention include polyethersulfone (PES), polycarbonate (PC), polyimide (PI), polyarylate (PAR), polyethylene terephthalate (PET), polyethylene naphthalate (PEN), and cycloolefin copolymer, but are not limited thereto. Suitable thermosetting polymers for the present invention may include, but are not limited to, epoxy resins and unsaturated polyester.

The organic/inorganic hybrid solution used as a coating solution in step a) is generally prepared by sol-gel type hydrolysis, but any kind of method may be used so long as it can prepare an organic/inorganic hybrid solution. In case of preparing an organic/inorganic hybrid solution by sol-gel type hydrolysis, it can be prepared by using alkoxysilane represented by Formula 1 below, silanealkoxide represented by Formula 2 below, or mixtures thereof as a raw material of the sol-gel type hydrolysis.

Rₓ¹Si(OR²)₍₄₋ₓ₎ <Formula 1>

where R¹ is C₁-C₂₀ alkyl, C₆-C₂₀ aryl, vinyl, acryl, methacryl or epoxy; R² is C₁-C₂₀ alkyl or C₆-C₂₀ aryl; x is an integer ranging from 1 to 3; and when R¹ and R² are alkyl, where the alkyl can be replaced with fluorine instead of hydrogen.

Si(OR³)₄ <Formula 2>

where R³ is C₁-C₂₀ alkyl or C₆-C₂₀ aryl; and when R³ is alkyl, where the alkyl can be replaced with fluorine instead of hydrogen.

Further, in alkoxysilane of Formula 1 above and silanealkoxide of Formula 2 above, Si can be replaced with other metals, such as Ti or Zr.

Specifically, trialkoxysilane (R¹Si(OR²)₃) where x is 1 in the alkoxysilane of Formula 1 and dialkoxysilane (R¹₂Si(OR²)₂) where x is 2 in the alkoxysilane of Formula 1 may be used. Representative examples of trialkoxysilane (R¹Si(OR²)₃) may include methyltrimethoxysilane, methyltriethoxysilane, ethyltrimethoxysilane, ethyltriethoxysilane, 3-glycidoxypropyltrimethoxysilane, 3-acryloxypropyltrimethoxysilane, 3-acryloxypropyltriethoxysilane, 3-methacryloxypropyltrimethoxysilane, 3-methacryloxypropyltriethoxysilane, vinyltriethoxysilane, and vinyltrimethoxysilane, but are not limited thereto. Representative examples of dialkoxysilane (R¹₂Si(OR²)₂) may include dimethyldimethoxysilane, dimethyldiethoxysilane, diethyldimethoxysilane, and diethyldiethoxysilane, but are not limited thereto. Suitable silanealkoxides (Si(OR³)₄) of Formula 2 may include tetraethylorthosilicate, tetramethylorthosilicate, tetraisopropoxysilicate, tetrabutoxysilicate and the like.

Generally, the organic/inorganic hybrid solution is prepared by sol-gel type hydrolysis of trialkoxysilane and silanealkoxide in a polar solvent, but it is also possible to prepare the same by sol-gel type hydrolysis of dialkoxysilane and silanealkoxide, by sol-gel type hydrolysis of dialkoxysilane and trialkoxysilane, and by sol-gel type hydrolysis of each of the dialkoxysilane and trialkoxysilane alone. Because it is possible to use several kinds of compounds including dialkoxysilane, trialkoxysilane and silanealkoxide listed above in a variety of combinations and molar ratios for the sol-gel type hydrolysis, many different types of organic/inorganic hybrid solutions can be prepared. The thus prepared organic/inorganic hybrid solution is coated on the surface of a transparent plastic film according to a conventional coating method in the art, followed by heat curing or photocuring to thereby form an organic/inorganic hybrid layer.

According to one embodiment of the present invention, silanealkoxide is mixed with a polar solvent and alkoxysilane was added, while stirring, to thereby prepare an organic/inorganic hybrid solution by sol-gel type hydrolysis. For the polar solvents, distilled water; alcohols, such as methanol, ethanol, isopropanol, and butanol; ketones, such as methylethylketone and methylisobutylketone; esters, such as ethylacetic acid and butylacetic acid; aromatic hydrocarbons, such as toluene and xylene; and halogenated hydrocarbons can be used alone or as a mixture thereof. As a catalyst for promoting the sol-gel type hydrolysis, acids, such as hydrochloric acid, nitric acid, sulfuric acid, acetic acid, and hydrogen fluoric acid (HF), or ammonia may be added to the polar solvent. Further, the mixed molar ratio of alkoxysilane and silanealkoxide may be in the range of 1:5 to 10:1. The above mixture may be subjected to extraction or dialysis to remove water, alcohol, acids or ammonia used as catalyst, to finally obtain an organic/inorganic hybrid solution.

The above organic/inorganic hybrid solution may be coated on the surface of a transparent plastic film by spin coating, dip coating, roll coating, screen coating, spray coating, spin casting, flow coating, screen printing, ink-jetting, drop casting, and the like with a thickness of 0.5 to 5 μm, followed by heat curing or photocuring, to thereby form an organic/inorganic hybrid layer. The heat curing process is carried out at a temperature lower than the heat distortion temperature of the transparent plastic film, while the curing conditions may be varied depending on the type and thickness of the transparent plastic film used. Further, photocuring is applicable when using a compound such as alkoxysilane of Formula 1 above where R¹ is an unsaturated hydrocarbon group such as vinyl, acryl, and methacryl, as a raw material of the sol-gel type hydrolysis. Since light exposure of the above compound causes the generation of free radicals and crosslinking of the unsaturated hydrocarbon groups, photocuring results in the formation of an organic/inorganic hybrid layer. For the photocuring process, conventional photoinitiators can be used. Suitable photoinitiators may include, but are not limited to 1-hydroxycyclohexylphenylketone (Irgacure 184), benzophenone, 3,3,4,4-tetra-(t-butyloxycarbonyl)benzophenone, 2-hydroxy-2-methylpropiophenone, and 2,2-diethoxyacetophenone. The photoinitiator may be used in an amount of 0.1 to 10 parts by weight based on 100 parts by weight of the organic/inorganic hybrid solution.

Since the thus formed organic/inorganic hybrid layer has properties that are intermediate between organic materials and inorganic materials depending on the ratio of Si—O bond and hydrocarbons, it carries out a buffering action between the transparent plastic film, which is an organic material, and the inorganic layer formed in the following step b). Accordingly, when external force is applied to the film or the film is contracted or expanded by heat, the organic/inorganic hybrid layer can reduce the stress generated at the interface between them and thereby prevent the formation of cracks on the gas barrier film or the separation of the gas barrier layer from the transparent plastic film.

In another embodiment, the method of the present invention may further include, before carrying out step a), the step of pre-treating the surface of the transparent plastic film with plasma. Specifically, after the transparent plastic film is placed in a plasma reaction chamber, the surface is treated with plasma generated by supplying gas, such as oxygen (O₂), helium (He), argon (Ar), nitrous oxide (N₂O), nitrogen (N₂), ammonia (NH₃), hydrogen (H₂), H₂O, or mixtures thereof. Further, any plasma source known in the art, including radio frequency (RF) power, medium frequency (MF) power, direct current (DC) power, microwave (MW) power and the like, may be used in this pre-treatment step so long as it is capable of generating plasma. Such pre-treatment of the surface of the transparent plastic film with plasma as described above increases the adhesiveness between the plastic film and the organic/inorganic hybrid layer to be coated in step a) and thereby prevents the occurrence of layer-peeling phenomenon between them.

Step b) is a characteristic step of the method according to the present invention, which involves forming an inorganic layer on the surface of the organic/inorganic hybrid layer formed in step a) by surface plasma treatment without using high vacuum deposition to thereby obtain a gas barrier layer. The inorganic layer formed in this step exhibits excellent gas barrier properties and has an organic/inorganic gradient interface structure at the interface between the inorganic layer and the organic/inorganic hybrid layer which shows a gradual change in composition from inorganic substances to organic/inorganic substances, moving from the inorganic layer to the organic/inorganic hybrid layer. Therefore, there is no crack formation or layer-peeling phenomenon at the interface between the inorganic layer and the organic/inorganic hybrid layer.

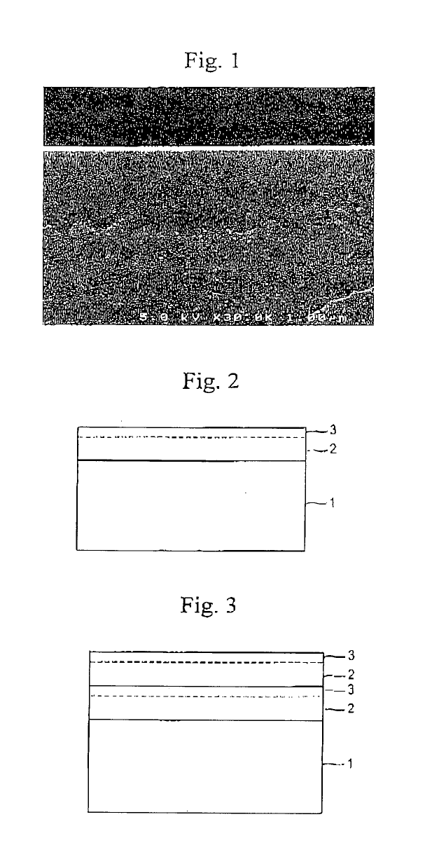

In step b), the inorganic layer is formed not by depositing a new layer onto the organic/inorganic hybrid layer under high vacuum, but by converting a part of the organic/inorganic hybrid layer into the inorganic layer while removing hydrocarbons from the surface thereof by plasma surface treatment. According to the results from analyzing the surface of the gas barrier layer fabricated according to the steps described above using XPS (X-ray photoelectron spectroscopy), the gas barrier layer of the present invention is composed of three regions: 1) the outside surface region where carbon is not detected; 2) the middle region beneath the outside surface region where the carbon content is gradually increased; and 3) the bottom region beneath the middle region where the carbon content remains constant. Namely, the outside surface region represents the inorganic layer formed in step b) by removing hydrocarbons from the surface of the organic/inorganic hybrid layer by surface plasma treatment according to the present invention, while the middle region represents the boundary region between the inorganic layer and the organic/inorganic hybrid layer which has an organic/inorganic gradient interface structure showing a gradual change in composition from inorganic materials to organic/inorganic materials and the bottom region represents the organic/inorganic hybrid layer formed in step a) having a constant carbon content. An observation of the fracture surface of the gas barrier layer formed according to the present invention with a scanning electron microscope (SEM) indicates that the boundary between the inorganic layer and the organic/inorganic hybrid layer is not clearly delineated due to the organic/inorganic gradient interface structure (see FIG. 1). When the composition of the interface between the inorganic layer and the organic/inorganic hybrid layer gradually changes from inorganic to organic/inorganic material due to the presence of the organic/inorganic gradient interface structure, the interface layer carries out a buffering action against external force or distortion and can thereby prevent the formation of cracks and the occurrence of layer-peeling.

In order to fabricate such an organic/inorganic gradient interface structure having a gradual change in composition according to the prior art methods, two or more layers each having a different composition have typically been repeatedly coated or deposited on a plastic substrate or successively deposited in a single process by varying reaction conditions (e.g., pressure, gas flow, composition ratio of mixed gases, plasma power etc.) over time. However, the above conventional methods have been problematic in that the same process had to be repeated a number of times or that it was difficult to gradually vary the reaction conditions in the reactor.

However, according to the method of the present invention, there is no need to coat or deposit two or more layers having different compositions a number of times or control the reaction conditions over time to form an organic/inorganic gradient interface structure having a gradual change in composition. The method of the present invention is capable of forming an organic/inorganic gradient interface structure having a gradual change in composition by simply carrying out the surface plasma treatment of an organic/inorganic hybrid layer and, thus, simplifies the process of fabricating a transparent gas barrier film, making mass-production possible.

Specifically, the surface plasma treatment in step b) is carried out by loading in a plasma reaction chamber the transparent plastic film where the organic/inorganic hybrid layer is formed on the surface in step a); lowering the atmospheric pressure inside the chamber; supplying reactive gas to the chamber; applying power to an electrode to generate plasma; and treating the surface of the organic/inorganic hybrid layer with plasma. The reactive gas for the surface plasma treatment according to the present invention is capable of removing carbon and includes, for example, O₂, N₂O, N₂, NH₃, H₂, H₂O, mixtures thereof and mixtures in combination with inert gases such as O₂/N₂O, O₂/N₂, O₂/NH₃, O₂/H₂, Ar/O₂, He/O₂, Ar/N₂O, He/N₂O, Ar/NH₃, He/NH₃, O₂/N₂/He, O₂/NH₃/He, O₂/N₂/Ar, O₂/NH₃/Ar, and so on. Any plasma sources including radio frequency (RF) power, medium frequency (MF) power, direct current (DC) power, and microwave (MW) power may be used for the surface plasma treatment so long as it is capable of generating plasma.

The surface plasma treatment in step b) is similar to the conventional plasma pre-treatment described above, but its objective and effects are totally different. While the conventional plasma pre-treatment is to enhance the adhesiveness between the transparent plastic film and the organic/inorganic hybrid layer formed thereon, the surface plasma treatment in step b) is to remove the hydrocarbons from the surface of the organic/inorganic hybrid layer to thereby convert a part of the organic/inorganic hybrid layer into an inorganic layer having an organic/inorganic gradient interface structure which can function as a gas barrier layer.

During the surface plasma treatment in step b), the thus formed inorganic layer includes several types of bonds, such as Si—O, Si—N, and Si—ON, depending on the type of reactive gas used, and its gas barrier properties can be modulated by regulating several parameters, such as plasma power, treatment pressure, treatment time, and the distance between the electrode and the substrate. In general, the higher the plasma power, the lower the treatment pressure, and the longer the treatment time are, more hydrocarbons are removed, which results in an increase in the thickness of the inorganic layer formed and an improvement in gas barrier properties. If the plasma power is high during the surface plasma treatment, the gas barrier properties of the inorganic layer can be improved in a short time. However, because there is a risk of deformation of the transparent plastic film due to the increase in temperature caused by the plasma treatment, it is necessary to appropriately regulate the plasma power and treatment time. The plasma treatment conditions may vary depending on the type of plasma power and the distance between the electrode and the substrate. According to another embodiment of the present invention, when using RF power as a plasma source in an experimental system having a powered electrode of 140 mm diameter and the 60 mm distance between the powered and ground electrode, the plasma surface treatment is carried out under the conditions as follows: gas flow of 2 to 7 sccm, output power of 50 to 600 W, treatment time of 10 seconds to 10 minutes, and treatment pressure of 10 to 500 mtorr. If the output power is not more than 50 W, it would be difficult to obtain the desired gas barrier properties with a surface plasma treatment of 10 minutes or less, whereas if the output power exceeds 600 W, the film may be damaged. Further, if the treatment pressure exceeds 500 mtorr or if the treatment time is not longer than 10 seconds, it is also difficult to achieve the desired gas barrier properties. An XPS analysis of the composition of the gas barrier film having an organic/inorganic gradient interface structure fabricated according to the plasma surface treatment of the present invention (where the sputtering rate is 10 nm/min on the basis of SiO₂, provided that the sputtering rate of the gas barrier film is identical) indicates that the inorganic layer has a thickness of 10 to 500 nm, where the Si/O ratio in the inorganic layer is in the range of 1.7 to 2.5.

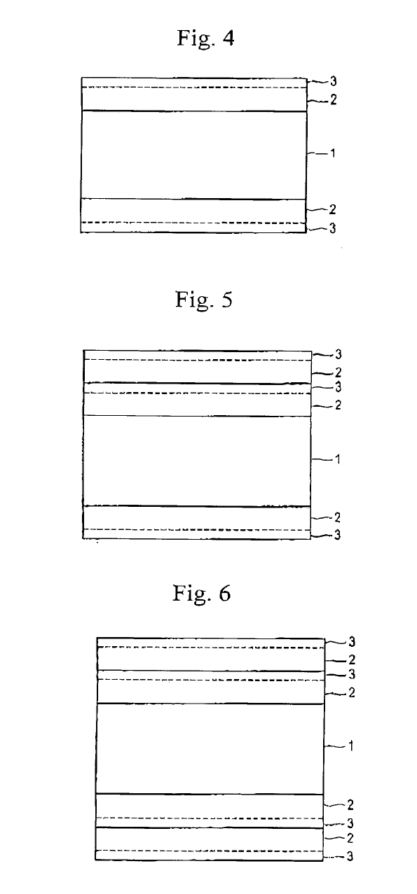

The method of the present invention is not limited to the embodiment of carrying out steps a) and b) on one side of the transparent plastic film, resulting in the formation of a pair of the inorganic layer and organic/inorganic layer on only one side of the transparent plastic film (see FIG. 2), but can include other embodiments of carrying out the steps repeatedly on one side of the transparent plastic film, resulting in the formation of two or more pairs of the inorganic layer and organic/inorganic layer on only one side (see FIG. 3); carrying out the steps once on both sides of the transparent plastic film, resulting in the formation of a pairs of the inorganic layer and organic/inorganic layer on each side (see FIG. 4); carrying out the steps repeatedly on both sides of the transparent plastic film, resulting in the formation of two or more pairs of the inorganic layer and organic/inorganic layer on each side (see FIGS. 5 and 6). Referring to FIG. 4, when carrying out steps a) and b) on both surfaces of the transparent plastic film, steps a) and b) may be carried out first on one side of the transparent plastic film, followed by carrying out steps a) and b) on the other side, or step a) may be carried out first on both sides of the transparent plastic film, followed by carrying out step b). Therefore, the present invention includes various forms of transparent gas barrier films, i.e., where a pair of the inorganic layer and organic/inorganic layer is formed on one side of the transparent plastic film; where two or more pairs of the inorganic layer and organic/inorganic layer are formed on one side of the transparent plastic film; where a pair of the inorganic layer and organic/inorganic layer is formed on both sides of the transparent plastic film; and where two or more pairs of the inorganic layer and organic/inorganic layer are formed on both sides of the transparent plastic film.

As described above, since the method of the present invention is capable of fabricating a gas barrier film by plasma surface treatment instead of deposition under high vacuum, it can mass-produce transparent gas barrier films having excellent gas barrier properties in an economical and simple manner. The transparent gas barrier film fabricated according to the method of the present invention has advantages in that there is no crack formation or layer-peeling phenomenon at the interface between the organic/inorganic hybrid layer and the inorganic layer due to the presence of an organic/inorganic gradient interface structure. Further, it exhibits high light transmittance, good surface hardness and high thermal resistance as well as excellent gas barrier properties. Therefore, the transparent gas barrier film of the present invention can be effectively used in the manufacture of a variety of display panels.

Embodiments of the present invention will now be described in more detail with reference to the following examples. However, the examples below are provided for purposes of illustration only and are not to be construed as limiting the scope of the invention.

### EXAMPLES

### Example 1

A polyethersulfone (PES) film having a thickness of 200 μm was used as the transparent plastic film, and its surface was pre-treated with plasma before the formation of an organic/inorganic hybrid layer thereon. In particular, the PES film was placed in a plasma reaction chamber, and the pressure inside the chamber was reduced below 10⁻³ torr by using a vacuum pump. While operating the vacuum pump, argon gas was injected into the chamber at a flow rate of 5 sccm, and plasma was generated at an RF output power of 100 W under a pressure of 50 mtorr. Under these conditions, the surface of the PES film was treated with plasma for several seconds.

### a) Formation of an Organic/Inorganic Hybrid Layer

After mixing 0.3 g of 95% acetic acid with 100 g of distilled water, 25.62 g of tetraethylorthosilicate (TEOS) was added thereto. Next, while stirring the resulting mixture, 33.51 g of methyltrimethoxysilane (MTMS) was added thereto at room temperature to thereby prepare an organic/inorganic hybrid solution. The molar ratio of tetraethylorthosilicate and methyltrimethoxysilane was 1:2. The thus prepared organic/inorganic hybrid solution was spin-coated on the surface of the plasma pre-treated PES film at a rate of 250 rpm, followed by heat curing at 130° C. for 1 hour to thereby form an organic/inorganic hybrid layer having a thickness of 3

### b) Formation of a Gas Barrier Layer

The PES film where the organic/inorganic hybrid layer was formed on the surface thereof in step a) was placed in a plasma reaction chamber, and the pressure inside the chamber was reduced below 10⁻³ torr by using a vacuum pump. While operating the vacuum pump, oxygen gas was injected into the chamber at a flow rate of 5 sccm, and plasma was generated at an RF output power of 100 W under a pressure of 50 mtorr. Under these conditions, the surface of the organic/inorganic hybrid layer was treated with plasma for 10 minutes to remove the hydrocarbons. As such, a transparent gas barrier film where the inorganic layer and organic/inorganic hybrid layer are formed on the transparent plastic film as a gas barrier layer having an organic/inorganic gradient interface structure was fabricated.

### Examples 2 to 14

The transparent gas barrier films in which the gas barrier layer having an organic/inorganic gradient interface structure is formed on the transparent plastic film were fabricated according to the same method as described in Example 1 except that the molar ratio of TEOS:MTMS in step a) and the type of plasma gas, RF output power and plasma treatment time in step b) were varied according to the following Table 1.

### Example 15

The transparent gas barrier films in which the gas barrier layer having an organic/inorganic gradient interface structure is formed on the transparent plastic film were fabricated according to the same method as described in Example 1 except that the RF output power and plasma treatment time in step b) were varied according to the following Table 1 and steps a) and b) were carried out twice on one side of the PES film.

### Example 16

The transparent gas barrier films in which the gas barrier layer having an organic/inorganic gradient interface structure is formed on the transparent plastic film were fabricated according to the same method as described in Example 1 except that the RF output power and plasma treatment time in step b) were varied according to the following Table 1 and steps a) and b) were carried out once on both sides of the PES film.

TABLE 1

| | | | Pressure | Output | Treatment |
|---|---|---|---|---|---|
| Example | TEOS:MTMS¹⁾ | Gas | (mtorr) | power(W) | time(min) |
| 1 | 1:2 | O₂ | 50 | 100 | 10 |
| 2 | 1:3 | O₂ | 50 | 100 | 10 |
| 3 | 1:2 | O₂ | 50 | 150 | 2 |
| 4 | 1:2 | O₂ | 50 | 150 | 3 |
| 5 | 1:2 | O₂ | 50 | 200 | 2 |
| 6 | 1:2 | O₂ | 50 | 200 | 5 |
| 7 | 1:2 | O₂ | 50 | 250 | 1 |
| 8 | 1:2 | O₂ | 50 | 250 | 2 |
| 9 | 1:2 | O₂ | 50 | 250 | 3 |
| 10 | 1:2 | O₂ | 50 | 300 | 0.5 |
| 11 | 1:2 | O₂ | 50 | 300 | 5 |
| 12 | 1:2 | O₂ | 15 | 200 | 5 |
| 13 | 1:2 | NH₃ | 50 | 250 | 3 |
| 14 | 1:2 | Ar/O₂²⁾ | 50 | 250 | 3 |
| 15 | 1:2 | O₂ | 50 | 250 | 1 |
| 16 | 1:2 | O₂ | 50 | 250 | 1 |

¹⁾molar ratio of TEOS and MTMS being used as raw material for preparing the organic/inorganic hybrid solution
²⁾flow rate of Ar and O₂ is 1:1

### Comparative Example 1

In order to confirm the gas barrier properties of the transparent gas barrier film fabricated according to the present invention, a gas barrier film was fabricated by carrying out only step a) under the same conditions as described in Example 1 without performing step 2).

### Test Example 1

### Measurement of Oxygen Transmission Rate

The oxygen transmission rate (OTR) values of the transparent gas barrier films fabricated in Examples 1 to 16 and Comparative Example 1 were measured by using an oxygen transmission rate apparatus (Oxtran 2/20 MB, Mocon) at 35° C. and 0% relative humidity, where the results are shown in Table 2 as follows.

TABLE 2

| | OTR(cc/m²/day) |
|---|---|
| Example 1 | 0.34 |
| Example 2 | 0.37 |
| Example 3 | 1.2 |
| Example 4 | 0.26 |
| Example 5 | 0.79 |
| Example 6 | 0.35 |
| Example 7 | 1.2 |
| Example 8 | 0.41 |
| Example 9 | 0.35 |
| Example 10 | 0.86 |
| Example 11 | 0.20 |
| Example 12 | 0.14 |
| Example 13 | 0.75 |
| Example 14 | 0.71 |
| Example 15 | not more than Mocon limit(0.05) |
| Example 16 | not more than Mocon limit(0.05) |
| Comparative Example 1 | 310 |

As shown in Table 2 above, while the transparent gas barrier films in which the gas barrier layer was formed on the surface of the transparent plastic film by plasma surface treatment according to Examples 1 to 16 of the present invention showed significantly low oxygen transmission rate from 0.05 cc/m²/day (Mocon limit) or below to 1.2 cc/m²/day at maximum, the transparent gas barrier film of Comparative Example 1 showed relatively high OTR of 310 cc/m²/day. These results suggest that the transparent gas barrier film of the present invention exhibits good gas barrier properties.

### Test Example 2

### Measurement of Film Durability

The transparent gas barrier film according to the present invention was subjected to a bending experiment to examine its durability, as follows.

The bending machine used in this test was manufactured according to ASTM D2236, and the transparent gas barrier film of Example 9 was cut into a size of 100 mm×30 mm to prepare the film sample. The length direction of the film sample was set to be parallel to the movement direction of the bending machine, and the film sample was then subjected to bending. Here, the bending test was performed under conditions of a bending frequency of 0.25 Hz, an angular displacement of ( 1/24)π and a repetition number of 5,000.

After the bending test was completed, the OTR value of the film sample was measured at 35° C. and 0% relative humidity according to the same method as described in Test Example 1, and the result was compared with that of the transparent gas barrier film before the bending test.

As a result, the transparent gas barrier film of Example 9 showed the same oxygen transmission rate of 0.35 cc/m²/day before and after the bending test, suggesting that the transparent gas barrier film of the present invention still exhibits good gas barrier properties even with the application of external force.

From the above results, it was confirmed that the transparent gas barrier film fabricated by plasma surface treatment according to the present invention exhibits low OTR and strong resistance to external force without any loss of performance. Such excellent gas barrier properties of the transparent gas barrier film according to the present invention can be achieved not by depositing an inorganic layer onto an organic/inorganic hybrid layer coated on a transparent plastic film under high vacuum, but by converting a part of the organic/inorganic hybrid layer into the inorganic layer while removing hydrocarbons from the surface thereof by plasma surface treatment.

Although the invention has been described in detail for purposes of illustration, it is understood that such detail is solely for that purpose, and variations can be made therein by those skilled in the art without departing from the spirit and scope of the invention which is defined by the following claims.

1. A method of fabricating a transparent gas barrier film with excellent gas barrier properties comprising:
a) coating an organic/inorganic hybrid solution on the surface of a transparent plastic film to form an organic/inorganic hybrid layer; and
b) treating the surface of the organic/inorganic hybrid layer formed on the transparent plastic film with plasma of reactive gas to form an inorganic layer having an organic/inorganic gradient interface structure.

2. The method according to claim 1, wherein the transparent plastic film in step a) is selected from the group consisting of ployethersulfone (PES), polycarbonate (PC), polyimide (PI), polyarylate (PAR), polyethylene terephthalate (PET), polyethylene naphthalate (PEN), cycloolefin copolymer, epoxy resin, and unsaturated polyester.

3. The method according to claim 1, wherein the organic/inorganic hybrid solution in step a) is prepared by sol-gel type hydrolysis.

4. The method according to claim 1, wherein the organic/inorganic hybrid solution in step a) is prepared by using a compound selected from the group consisting of: alkoxysilane represented by Formula 1:
Rₓ¹Si(OR²)₍₄₋ₓ₎ <Formula 1>
wherein R¹ is C₁-C₂₀ alkyl, C₆-C₂₀ aryl, vinyl, acryl, methacryl or epoxy; R² is C₁-C₂₀ alkyl or C₆-C₂₀ aryl; x is an integer ranging from 1 to 3; and when R¹ and R² are alkyl, said alkyl can be replaced with fluorine instead of hydrogen;
silanealkoxide represented by Formula 2:
Si(OR³)₄ <Formula 2>
wherein R³ is C₁-C₂₀ alkyl or C₆-C₂₀ aryl; and when R³ is alkyl, said alkyl can be replaced with fluorine instead of hydrogen;
and any mixtures thereof.

5. The method according to claim 4, wherein the alkoxysilane compound includes trialkoxysilane (R¹Si(OR²)₃) and dialkoxysilane (R¹₂Si(OR²)₂).

6. The method according to claim 5, wherein the trialkoxysilane (R¹Si(OR²)₃) compound is selected from the group consisting of methyltrimethoxysilane, methyltriethoxysilane, ethyltrimethoxysilane, ethyltriethoxysilane, 3-glycidoxypropyltrimethoxysilane, 3-acryloxypropyltrimethoxysilane, 3-acryloxypropyltriethoxysilane, 3-methacryloxypropyltrimethoxysilane, 3-methacryloxypropyltriethoxysilane, vinyltriethoxysilane, and vinyltrimethoxysilane.

7. The method according to claim 5, wherein the dialkoxysilane (R¹₂Si(OR²)₂) compound is selected from the group consisting of dimethyldimethoxysilane, dimethyldiethoxysilane, diethyldimethoxysilane, and diethyldiethoxysilane.

8. The method according to claim 4, wherein the silanealkoxide (Si(OR³)₄) compound is selected from the group consisting of tetraethylorthosilicate, tetramethylorthosilicate, tetraisopropoxysilicate, and tetrabutoxysilicate.

9. The method according to claim 4, wherein when a mixture of the alkoxysilane and silanealkoxide is used in step a), the alkoxysilane and silanealkoxide compounds are mixed in a molar ratio of 1:5 to 10:1.

10. The method according to claim 1, wherein the organic/inorganic hybrid layer in step a) is formed by heat curing or photocuring the organic/inorganic hybrid solution coated on the surface of the transparent plastic film.

11. The method according to claim 1, wherein the organic/inorganic hybrid layer formed in step a) has a thickness ranging from 0.5 to 5 μm.

12. The method according to claim 1, wherein the reactive gas in step b) is selected from the group consisting of oxygen (O₂), nitrous oxide (N₂O), nitrogen (N₂), ammonia (NH₃), hydrogen (H₂), H₂O, mixtures thereof, and mixtures in combination with inert gas.

13. The method according to claim 1, wherein the inorganic layer in step b) is formed by converting a part of the organic/inorganic hybrid layer into an inorganic layer while removing hydrocarbons from the surface thereof by plasma surface treatment.

14. The method according to claim 1, wherein the inorganic layer formed in step b) has a thickness ranging from 10 to 500 mm.

15. The method according to claim 1, wherein the interface between the inorganic layer and the organic/inorganic hybrid layer is not clearly delineated due to the presence of an organic/inorganic gradient interface structure.

16. The method according to claim 1, wherein steps a) and b) are carried out once on one side of the transparent plastic film, carried out repeatedly on one side of the transparent plastic film, carried out once on both sides of the transparent plastic film, or carried out repeatedly on both sides of the transparent plastic film.

17. The method according to claim 16, wherein when carrying out steps a) and b) on both sides of the transparent plastic film, steps a) and b) are carried out first on one side of the transparent plastic film, followed by carrying out steps a) and b) on the other side of the transparent plastic film, or step a) is carried out first on both sides of the transparent plastic film, followed by carrying out step b) thereon.

18. A transparent gas barrier film fabricated according to the method of claim 1, comprising a transparent plastic film, an organic/inorganic hybrid layer and an inorganic layer, wherein the interface between the organic/inorganic hybrid layer and the inorganic layer has an organic/inorganic gradient interface structure showing a gradual change in composition from inorganic materials to organic/inorganic materials.

19. The transparent gas barrier film according to claim 18, wherein the inorganic layer is formed by converting a part of the organic/inorganic hybrid layer into an inorganic layer while removing hydrocarbons from the surface thereof by plasma surface treatment.

20. The transparent gas barrier film according to claim 18, wherein the interface between the inorganic layer and the organic/inorganic hybrid layer is not clearly delineated due to the presence of an organic/inorganic gradient interface structure.
